(19) United States
(12) Patent Application Publication
(10) Pub. No.: US 2026/0278544 A1
(43) Pub. Date: Sep. 17, 2026

(54) INTELLIGENT INVENTORY MONITORING SYSTEM WITH INTERNET OF THINGS SENSOR DEVICES, PREDICTIVE ANALYTICS, AND AUTOMATED REPLENISHMENT

(71) Applicant: FRESHNOX, LLC, YPSILANTI, MI (US)

(72) Inventors: MANIKANDAN SOMASUNDARAM, YPSILANTI, MI (US); DEBASHISH SAHU, YPSILANTI, MI (US); ARASAKUMAR SUBRAMANI, ANN ARBOR, MI (US)

(21) Appl. No.: 19/566,907

(22) Filed: Mar. 13, 2026

Related U.S. Application Data
(60) Provisional application No. 63/772,896, filed on Mar. 17, 2025.

(51) Int. Cl. G06Q 10/087; G06Q 30/0601

(52) U.S. Cl. CPC G06Q 10/08774; G06Q 10/08772; G06Q 30/06333; G06Q 30/0635; G06Q 2220/00

(57) ABSTRACT

An intelligent inventory monitoring system includes sensor devices associated with containers and configured to generate fill-state signals using non-contact distance ranging. Devices are provisioned using a short-range protocol and transmit telemetry using a network protocol to a data processing service that validates telemetry, computes inventory levels from container configuration data, and stores time-stamped levels. An analytics engine detects consumption and refill events, estimates consumption rates, and predicts depletion metrics. An alert engine generates notifications based on inventory level thresholds and predicted depletion thresholds. A shopping workflow subsystem adds items to an internal shopping list and optionally supports retailer or aggregator integration including authenticated account connectivity, product-to-SKU mapping, and cart actions with user approval or optional automatic reorder within constraints. Expiry tracking is optionally supported by storing, inferring, or receiving an expiration attribute and generating expiry-based notifications.

### CROSS REFERENCE TO RELATED APPLICATIONS

This application claims the benefit of priority to U.S. Provisional Patent Application No. 63/772,896, filed Mar. 17, 2025, the entire disclosure of which is incorporated herein by reference

### TECHNICAL FIELD

The present disclosure relates generally to inventory management systems and, more particularly, to intelligent inventory monitoring using sensor-equipped containers or retrofit sensor modules, wireless communications, analytics, alerting, and automated replenishment integrations.

### BACKGROUND

Many households and enterprises store consumable materials in containers such as jars, bins, canisters, bottles, hoppers, and other receptacles. Users commonly estimate remaining quantities by visual inspection and memory. This produces inaccuracies, stockouts, waste, and inefficiency.

Existing solutions often require manual entry, barcode or RFID scanning, or weight-based sensing that can be sensitive to container mass, product density, or placement. Camera-based solutions may be limited by lighting, occlusion, and container opacity. Accordingly, there remains a need for an automated, low-power, retrofit-friendly system that measures actual physical fill level, learns consumption patterns, predicts depletion, and connects inventory state to purchasing workflows.

### SUMMARY

The present disclosure provides systems, devices, and methods for automated inventory monitoring and replenishment. In various embodiments, one or more sensor devices associated with containers generate signals indicative of an amount of product remaining, and a processing subsystem computes inventory levels, derives analytics, and generates notifications and replenishment actions. The disclosed embodiments are provided as non-limiting examples to illustrate features that may be claimed individually or in combination.

In certain embodiments, the system is configured as a physical, level-based intelligent replenishment platform that integrates with retailer and aggregator platforms to streamline shopping workflows. For example, the system may (i) calculate an inventory level for a container based on sensor readings, (ii) detect consumption and refill events, (iii) predict depletion or time-to-depletion, and (iv) generate replenishment actions such as adding an item to an internal shopping list and, optionally, adding an item to a retailer cart with user approval.

Retail and aggregator integration may include maintaining internal product-to-SKU mapping, connecting user accounts to one or more external platforms using secure authentication (for example OAuth), and supporting multiple operational modes. In a default mode, the system adds items to an internal shopping list. In a preferred mode, the system adds items to a retailer or aggregator cart with user approval. In an optional advanced mode, the system supports automatic reordering within user-defined constraints.

In one embodiment, a sensor device is integrated into a container lid. In other embodiments, the sensor device is implemented as a retrofit lid or an attachable module configured for use with third-party containers. Sensor modalities can include non-contact distance ranging (for example time-of-flight, ultrasonic, radar, or LIDAR). In some embodiments, a camera module and sensor fusion are provided as optional enhancements.

Provisioning can be performed using a first wireless protocol (for example Bluetooth Low Energy) to securely transfer network credentials and configuration, while operational telemetry may be transmitted using a second protocol (for example Wi-Fi). A secure adoption workflow associates devices with accounts using tokens and device identifiers.

In certain embodiments, expiry tracking is supported as an optional enhancement. The system may store, infer, or receive an expiration attribute for a monitored product (for example an expiry date, best-by date, use-by date, open date, or discard date) and generate expiry-based notifications. Expiry functionality is configured to complement level tracking and replenishment workflows and is not required in all embodiments.

In certain embodiments, an automated inventory monitoring system includes one or more sensor devices each associated with a respective container, each sensor device including a processor, a power system, at least one sensor configured to generate a fill-state signal indicative of an amount of product remaining, and at least one wireless communication interface. The system further includes a data processing subsystem configured to receive telemetry from the sensor devices over a network, validate the telemetry, compute an inventory level for each container based at least in part on the fill-state signal and container configuration data, and store computed inventory levels in persistent storage. An alerting subsystem compares the computed inventory level to one or more user-configurable thresholds and generates a notification when a threshold condition is satisfied.

In optional embodiments, the system includes an analytics subsystem configured to analyze stored inventory levels over time to detect consumption events, detect refill events, estimate a consumption rate, and generate a predicted depletion metric, and the alerting subsystem is optionally configured to compare the predicted depletion metric to one or more user-configurable thresholds.

In certain embodiments, the sensor comprises a non-contact distance ranging sensor oriented to measure a distance from the sensor device to a product surface within the container, including time-of-flight sensors. Provisioning can be performed using a short-range protocol (for example Bluetooth Low Energy) and operational telemetry can be transmitted using Wi-Fi. Sensor devices may be integrated into a lid, implemented as a retrofit lid, or provided as an attachable module configured for attachment to third-party containers.

In certain embodiments, a shopping workflow subsystem responds to a threshold condition by adding an item corresponding to a monitored product to an internal shopping list. The shopping workflow subsystem may connect a user account to a retailer platform or an aggregator platform using secure authentication (for example OAuth) and may maintain product-to-SKU mapping records used to prepare cart-add requests. In some embodiments, cart-add actions occur only after receiving user approval through a client application. Duplicate suppression may be applied such that an item is not re-added to the shopping list or cart until a refill event is detected or a reset condition is satisfied. Constrained auto-reorder may be provided as an optional mode that is off by default and requires affirmative user opt-in, and when enabled may operate under user-defined constraints.

In optional embodiments, an expiry management subsystem stores, infers, or receives an expiration attribute associated with a respective container, computes an expiry metric based on the expiration attribute, and generates an expiry-based notification when the expiry metric satisfies an expiring-soon threshold or an expired threshold. In some embodiments, the expiration attribute includes an open date and a discard date computed as open date plus a category-specific stability duration.

In optional embodiments, the sensor device includes a camera module, and the system uses image data to validate fill-level estimation and/or to perform optical character recognition for expiration attribute capture.

In certain embodiments, the system monitors each container independently such that a consolidated inventory view across multiple containers of a same product type and first-expire-first-out (FEFO) prioritization across multiple containers are not required for operation.

This Summary is provided to introduce a selection of concepts in simplified form that are further described below in the Detailed Description. This Summary is not intended to identify key features or essential features of the claimed subject matter, nor is it intended to limit the scope of the claims. Other features and advantages will become apparent from the following description, the drawings, and the claims.

### BRIEF DESCRIPTION OF THE DRAWINGS

The accompanying drawings, which are incorporated herein and form a part of this specification, illustrate examples of the disclosed subject matter. The drawings are provided for purposes of illustration and explanation only and are not intended to be limiting. Like reference numerals refer to like elements throughout.

FIG. 1 illustrates a system architecture overview including a sensor device subsystem, a data processing subsystem, a mobile application subsystem, and a retail integration subsystem.

FIG. 2 illustrates a sensor device hardware block diagram including a distance ranging sensor, power management, a microcontroller unit, communication modules, and optional status indicators.

FIG. 3 illustrates a device provisioning flow including discovery, secure short-range handshake, network credential transfer, device record creation, token generation, and adoption.

FIG. 4 illustrates a data flow from a sensor device through a message broker and data processing service to a mobile application and notification channels, with optional analytics.

FIG. 5 illustrates an inventory level calculation based on a measured distance and container height.

FIG. 6 illustrates a consumption analytics processing flow including event detection, aggregation, and prediction outputs.

FIG. 7 illustrates alert generation logic including percentage and time-based triggers and suppression of duplicate alerts.

FIG. 8 illustrates a retail integration architecture for adding low-inventory items to shopping lists and retailer carts via mapping and authentication.

FIG. 9 illustrates an exemplary mobile application user interface flow.

FIG. 10 illustrates a device adoption workflow with secure token validation and association of a device with a user account.

The drawings depict exemplary embodiments and are not necessarily to scale. Features shown in one figure may be combined with features shown in other figures in accordance with the disclosure. Additional embodiments will be apparent to those of ordinary skill in the art based on the following Detailed Description.

### DETAILED DESCRIPTION

The following detailed description is provided to enable any person skilled in the art to make and use the disclosed subject matter. Various modifications will be readily apparent, and the generic principles may be applied to other embodiments. Accordingly, the disclosure is not intended to be limited to the embodiments shown, but is to be accorded the widest scope consistent with the principles and features described herein.

For purposes of description, the terms “comprising”, “including”, and “having” are inclusive and mean “including but not limited to”. Unless otherwise indicated, the terms “a” and “an” include one or more. Ranges are inclusive of endpoints. The term “or” is inclusive. The term “module” can refer to hardware, firmware, software, or a combination thereof.

Definitions and Interpretation. Unless otherwise specified, features described with respect to a particular embodiment may be combined with features of other embodiments. Any reference to a component being “configured to” perform a function encompasses hardware, firmware, software, and combinations thereof. References to “inventory” include consumables, parts, ingredients, supplies, liquids, powders, solids, and any other measurable product. References to “container” include jars, bins, boxes, bottles, canisters, hoppers, cartridges, dispensers, pouches, blister packs, and packages, whether rigid, semi-rigid, or flexible. References to a “lid” include caps, closures, covers, tops, and any component attached to or adjacent a container opening. Values and thresholds may be absolute, relative, per-unit, per-household, per-location, or per-enterprise, and may be expressed in percentage, distance, mass, volume, count, or time units.

Reference Architecture Variations. The system 100 may be implemented as a cloud-hosted service, an on-premises deployment, a hybrid deployment, or a peer-to-peer deployment. In a cloud-hosted service, telemetry may be received by an internet-facing endpoint or message broker 110 and processed by a stateless compute service 112 that writes to storage 114. In an on-premises deployment, processing and storage may be performed by an on-site server, gateway, or network appliance. In a hybrid deployment, certain functions such as alerting may be local while analytics and long-term storage are remote. In a peer-to-peer deployment, one or more mobile devices or gateways may coordinate local processing and synchronize results.

Container Association and Identity. A sensor device may be associated with a container using any of: a user selection within the mobile application, a printed identifier on the device, a QR code, a barcode, an NFC tag, an RFID tag, a device certificate, a cryptographic key pair, or a combination thereof. In some embodiments, the system supports reassignment, for example when a container is repurposed for a different product, and maintains an audit trail of such changes. A container record may include product identifiers, brand, pack size, units, preferred reorder quantity, substitution preferences, and location metadata.

Sensing Modalities and Measurement Models. While non-contact distance ranging is a preferred modality, the fill-state signal can be generated using any modality capable of inferring remaining quantity. Non-limiting examples include: distance to a surface (for example time-of-flight, ultrasonic, radar, or LIDAR), mass or weight measurement, pressure, acoustic resonance, capacitance, inductance, conductivity, impedance, strain, flow rate, valve actuation counts, dispensing events, computer vision, and combinations thereof. In some embodiments, a measurement model converts raw sensor values to an inventory level using calibration parameters, container geometry parameters, environmental compensation parameters, and confidence metrics. The measurement model may include a mapping from level percentage to volume remaining for non-linear geometries, including tapered containers, irregular containers, or containers with internal features.

Calibration and Setup Options. Container configuration data can be obtained by (i) manual entry of a height or other dimension, (ii) selection from a catalog of known containers, (iii) scanning a package identifier, (iv) automated calibration by requesting the user to provide an empty reading and a full reading, or (v) inference using a learned model. For example, during setup, the mobile application may prompt a user to place an empty container under a lid-mounted sensor and then fill the container to a known level to compute offsets and scaling factors. In some embodiments, calibration may be updated over time to compensate for sensor drift, mounting changes, or environmental effects.

Placement and Orientation Alternatives. The sensor device may be mounted above, below, lateral to, or within a container. For a lid-integrated device, the sensor may point downward toward a product surface. For a side-mounted device, the sensor may point inward through a transparent window or may sense a float or level indicator. For a bottom-mounted device, the sensor may sense a distance to a surface from below through a window. In a shelf-mounted or room-mounted configuration, the sensor device may include multiple sensing elements or may scan across a field of view to obtain per-container readings.

Power Management and Measurement Scheduling. The sensor device can implement duty cycling and measurement scheduling to extend battery life. Measurement intervals may be fixed, user-configurable, predicted by a usage model, or adaptive based on rate of change. For example, if consumption is slow and stable, the device may measure once per day. If a rapid change is detected, the device may temporarily increase sampling to confirm a consumption event or to refine a depletion prediction. The device may enter a deep sleep state between measurements, and may wake based on a timer, a motion sensor, a lid open event, a vibration sensor, or a user interaction.

Local Processing and Edge Decisions. In some embodiments, the sensor device computes a local inventory level, a local confidence metric, or a local event classification before transmitting telemetry. Local processing may reduce bandwidth and may reduce cloud compute cost. For example, the device may transmit a level only when a change exceeds a threshold or when a scheduled report time occurs. In other embodiments, raw measurements are transmitted to enable server-side algorithm updates without device changes.

Connectivity and Protocol Alternatives. While BLE and Wi-Fi are described as non-limiting examples, other provisioning and operational protocols may be used. Provisioning may use Wi-Fi access point mode, NFC tap-to-provision, QR code transfer of credentials, USB, or a gateway-assisted enrollment. Operational communications may use cellular, LoRa, Zigbee, Thread, Z-Wave, Bluetooth mesh, or proprietary protocols. In some embodiments, a local gateway relays telemetry from multiple devices to the data processing subsystem. Telemetry payloads may include timestamps, device identifiers, firmware version, battery state, confidence metrics, raw measurements, derived levels, and diagnostic flags.

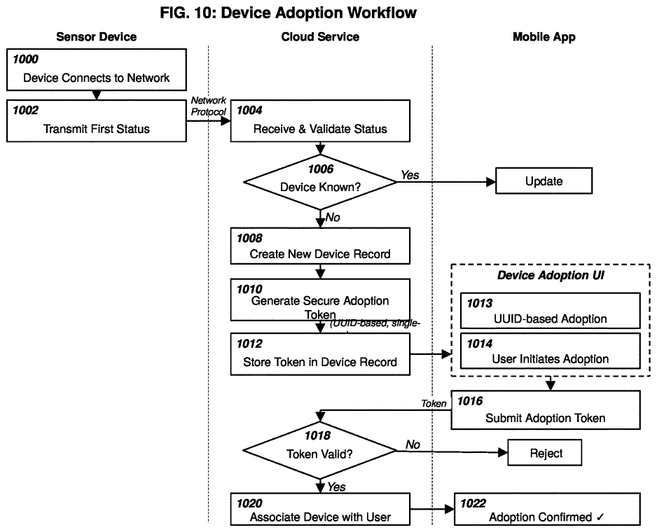

Security and Identity Details. The adoption token described with respect to FIG. 10 may be single-use, time-limited, cryptographically signed, and bound to a device identifier. Devices may use certificates, secure elements, or trusted platform modules to protect keys. Transport security may include TLS, mutual TLS, or application-layer encryption. Firmware updates may be verified using a signature chain and may include rollback prevention. In some embodiments, the system supports device attestation and may refuse service to devices failing attestation.

Event Detection and Smoothing. Consumption events may be detected by analyzing changes between consecutive levels, by applying smoothing filters, by rejecting outliers, and by evaluating confidence metrics. Refill events may be detected by increases beyond a threshold and may be confirmed using multiple samples to avoid false positives. In some embodiments, the system compensates for temporary disturbances such as container movement, sloshing of liquids, uneven surfaces, and vibration. In some embodiments, different detection thresholds are applied for different product types or container types.

Prediction Model Alternatives. The prediction engine 612 may implement moving averages, exponential smoothing, regression models, state-space models, Bayesian models, survival analysis, or machine learning approaches. Inputs may include time-of-day usage patterns, day-of-week effects, household size, historical refill cycles, delivery lead time, and seasonality. Predictions may be accompanied by confidence intervals. In some embodiments, the model adapts after each refill event and may treat a refill as a boundary between consumption segments.

Alerts, Controls, and User Experience Variations. Alerts may be threshold-based, trend-based, or schedule-based. A user may configure different thresholds per product, per location, or per user role. Quiet hours may suppress non-urgent alerts. Escalation may notify a secondary user if a primary user does not acknowledge an alert. Bundling may group multiple low inventory items into a single message. In some embodiments, the system generates an actionable prompt within a mobile application that allows one-tap add-to-list, one-tap reorder, or one-tap mark-as-refilled.

Commerce and Procurement Variations. Retail integration may use direct retailer APIs, third-party aggregator platforms, or enterprise procurement systems. Product mapping may support preferred brands, substitutions, minimum order quantities, pack sizes, and price thresholds. In some embodiments, the system pre-populates a shopping list without automatically adding to a cart unless user approval is provided. In other embodiments, the system supports automatic reorder subject to configurable constraints such as maximum spend, maximum frequency, or approval workflows.

Independent Container Monitoring and Optional Multi-Container Features. In certain embodiments, each sensor device is configured to monitor a single container containing a single product, and inventory calculations, depletion predictions, alerts, and replenishment actions are performed on a per-container basis. In these embodiments, a consolidated inventory view across multiple containers of a same product type is not required. Likewise, first-expire-first-out (FEFO) prioritization across multiple containers of a same product type is not required and is not necessary for operation of the level-based replenishment workflows described herein.

In some embodiments, multiple containers may contain a same product type (for example, a user may maintain multiple packages or containers of a same item), and the system may still operate independently for each container without aggregating quantities across the containers. For example, the system may generate an internal shopping list entry or cart recommendation based on an individual container crossing a threshold, without requiring knowledge of other containers that contain the same product type.

In optional embodiments, including enterprise embodiments, multi-container aggregation, consolidated inventory views, and coordination logic (including FEFO) may be implemented as enhancements. Such enhancements may be used for reporting, auditing, compliance, or specialized workflows, but are not required for the consumer operation of the system.

Sharing and Permission Models. Multi-user sharing can be implemented with role-based permissions, including owner, admin, editor, and viewer roles. Enterprises may restrict visibility by location, department, or cost center. Audit logs may record adoption events, configuration changes, threshold changes, and reorder actions. In some embodiments, the system supports temporary access, for example for caregivers or maintenance staff.

Additional Use Cases and Product Types. The system may monitor pantry items, refrigerated items, freezer items, liquids, powders, pet food, pharmaceuticals, medical supplies, chemicals, spare parts, office supplies, and hospitality items. For expirable items, the system may maintain an expiration record and generate expiration alerts separate from level alerts. In some embodiments, the system monitors a dispensing device and derives consumption from dispenser actuation rather than level measurement.

The embodiments described herein provide explicit support for alternative claim scopes. For example, independent claims may be directed to a system, a method, a device, a computer-readable medium, a server-side service, a gateway, or a combination thereof. Claim elements such as the sensor type, the communication protocol, the provisioning mechanism, the level computation formula, the prediction model, the alert type, and the commerce workflow are described as optional or selectable features that may be added, removed, or replaced without departing from the disclosure. Unless a feature is expressly stated as required, it may be omitted in certain embodiments.

Industry coverage and non-limiting use-case embodiments. The disclosed system may be deployed in a wide range of environments and for a wide range of inventory types, including consumer and residential inventory, pet and animal care, pharmacy and healthcare supplies, beauty and personal care, food service and hospitality, and industrial or enterprise consumables. In each environment, the system may implement one or more of: (i) inventory level tracking, (ii) predicted depletion metrics, (iii) replenishment workflows including shopping list generation, optional cart actions with user approval, and optional automatic reorder within constraints, and (iv) optional expiry tracking using expiration attributes (expiry date, best-by date, use-by date, open date, discard date). In enterprise embodiments, additional optional features may include multi-location reporting, approvals, audit logs, and optional lot or batch tracking.

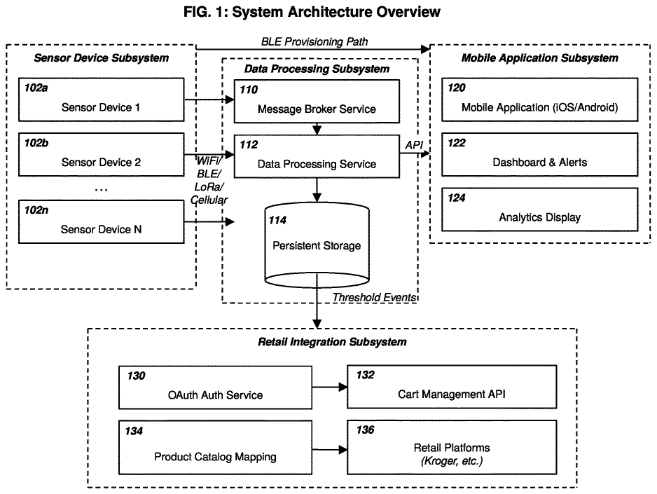

### 1. System Architecture (FIG. 1)

FIG. 1 depicts an intelligent inventory monitoring system 100 including a sensor device subsystem 102 having one or more sensor devices 102a, 102b, . . . , 102n; a data processing subsystem 110, 112, 114; a mobile application subsystem 120, 122, 124; and an optional retail integration subsystem 130, 132, 134, 136. Sensor devices transmit readings to a message broker service 110 and a data processing service 112 for validation, level calculation, and persistence in storage 114. Mobile application 120 receives data and presents dashboards 122 and analytics 124. Retail integration may include an OAuth service 130, cart management API 132, product catalog mapping 134, and retailer platforms 136.

In some embodiments, sensor devices communicate with the data processing subsystem using Wi-Fi, cellular, LoRa, or other network communications. Provisioning can be performed using a short-range protocol such as Bluetooth Low Energy (BLE). In some embodiments the same protocol is used for both provisioning and operation.

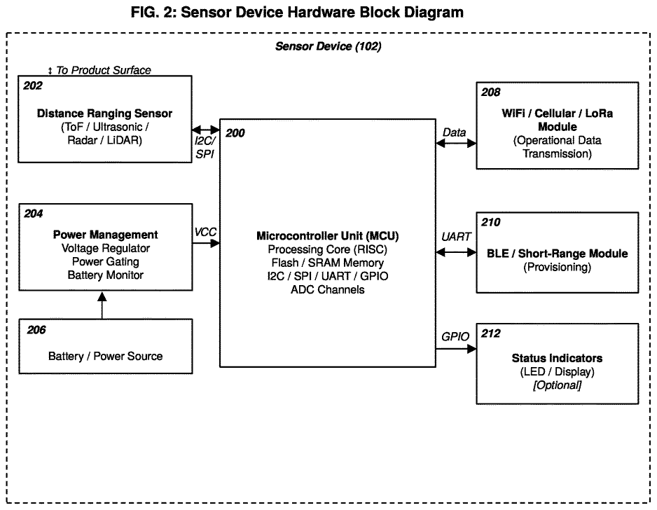

### 2. Sensor Device Hardware (FIG. 2)

FIG. 2 illustrates a sensor device 102 that can be integrated into a container lid, coupled to a container body, attached externally to an existing container. The sensor device includes a microcontroller unit (MCU) 200 coupled to a distance ranging sensor 202 and a power management module 204 supplied by a power source 206. The MCU 200 communicates with operational network module 208 (for example Wi-Fi, cellular, or LoRa) and may communicate with a short-range module 210 (for example BLE) for provisioning. Optional status indicators 212 can provide local feedback.

Distance ranging sensor 202 can include time-of-flight optical sensors, ultrasonic sensors, radar or microwave sensors, LIDAR, structured light sensors, capacitive or inductive proximity sensors, or other non-contact technologies. In some embodiments, the sensor is oriented downward from a lid toward a product surface within a container. In other embodiments, the sensor is oriented laterally or upward depending on placement and container geometry.

Power management module 204 can include voltage regulation, power gating, battery monitoring, charging circuitry, wireless charging circuitry, or energy harvesting interfaces. The sensor device may support multiple power states including active measurement, connected standby, deep sleep, and ultra-low power modes. Measurement and transmission intervals can be adaptive based on remaining power or confidence in measurements.

In some embodiments, the sensor device includes a camera module or other imaging sensor. The system may use vision-based estimation to determine fill level, identify a product label, detect anomalies, or validate a distance-based estimation. In some embodiments, sensor fusion combines distance sensing with image analysis and selects a sensing method based on accuracy, power budget, container type, or product characteristics.

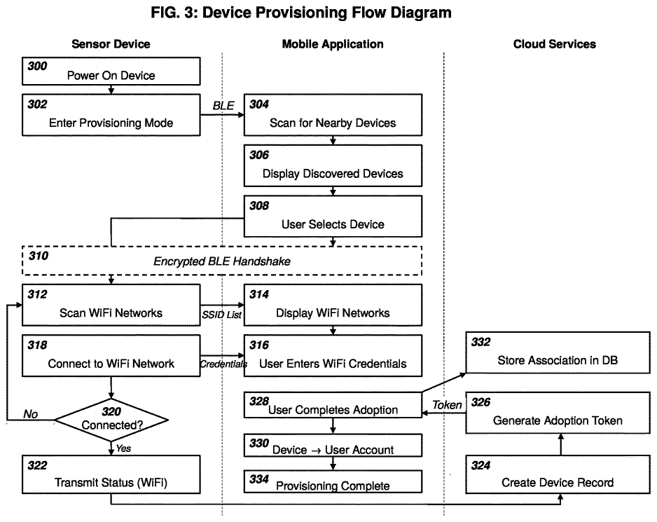

### 3. Provisioning and Secure Adoption (FIGS. 3 and 10)

FIG. 3 depicts an exemplary provisioning flow. A sensor device powers on (step 300) and enters provisioning mode (step 302). A mobile application scans for nearby devices (step 304), displays discovered devices (step 306), and receives a user selection (step 308). An encrypted short-range handshake is established (step 310). The sensor device scans available networks (step 312) and provides network options to the mobile application (step 314). The user enters credentials (step 316), and the device attempts connection (step 318). If connected (step 320), the device transmits status to a cloud service (step 322). The cloud service creates a device record (step 324), generates an adoption token (step 326), stores the association (step 332), and the mobile application completes adoption (step 328) to associate the device with a user account (step 330).

FIG. 10 depicts an adoption workflow wherein a device connects to a network (step 1000) and transmits first status (step 1002). The cloud service receives and validates status (step 1004) and determines whether the device is known (step 1006). If unknown, the service creates a new device record (step 1008) and generates a secure adoption token (step 1010) that is stored (step 1012). The mobile application presents a device adoption interface (steps 1013-1014) and submits the token (step 1016). The cloud service validates the token (step 1018) and associates the device with a user (step 1020). Upon confirmation (step 1022), the device is managed under the user account. Tokens may be UUID-based, single-use, time-limited, and cryptographically protected.

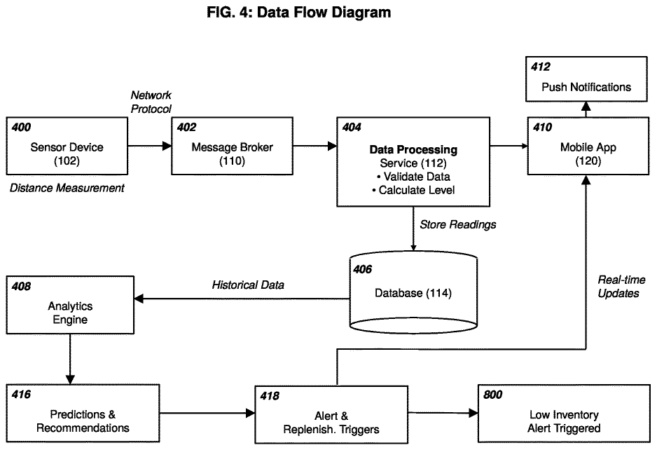

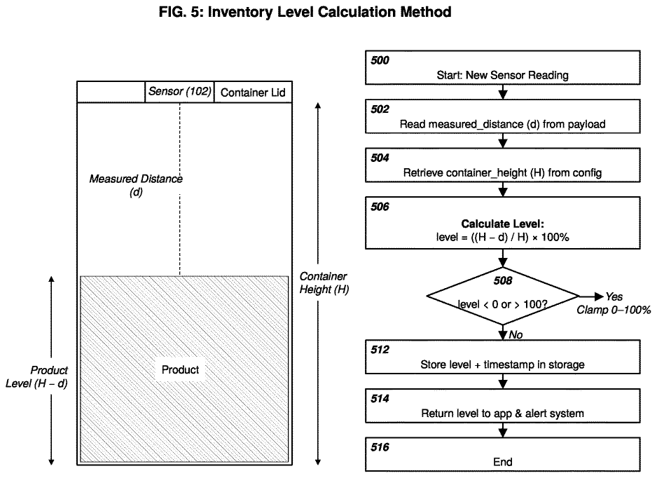

### 4. Data Flow, Validation, and Level Calculation (FIGS. 4 and 5)

FIG. 4 illustrates a data flow in which sensor device 102 transmits distance measurements to message broker 110 (step 402), which forwards data to a data processing service 112 (step 404). The data processing service validates data, calculates an inventory level, and stores readings in database 114 (step 406). Mobile application 120 retrieves real-time updates (step 410) and may trigger push notifications 412. An analytics engine 408 may analyze historical data to produce predictions and recommendations 416 that drive alert and replenishment triggers 418 resulting in a low inventory event 800.

FIG. 5 illustrates an inventory level calculation method. In one embodiment, a measured distance d from the sensor device to the product surface is read from a payload (step 502). A container height H is retrieved from configuration (step 504). A fill level percentage is calculated, for example level=((H−d)/H)×100 (step 506), optionally clamped to 0-100 percent (step 508). The calculated level and a timestamp are stored (step 512) and returned to the application and alert subsystem (step 514).

Container parameters can be obtained by manual user entry, selection from a catalog, barcode scan, QR code, NFC tag, or inferred from sensor signals. In some embodiments, the system stores additional geometric parameters such as minimum measurable distance, sensor mounting offset, container taper, or non-linear level-to-volume conversion curves. For example, a container model can map level percentage to volume remaining and can be used for more accurate consumption estimation.

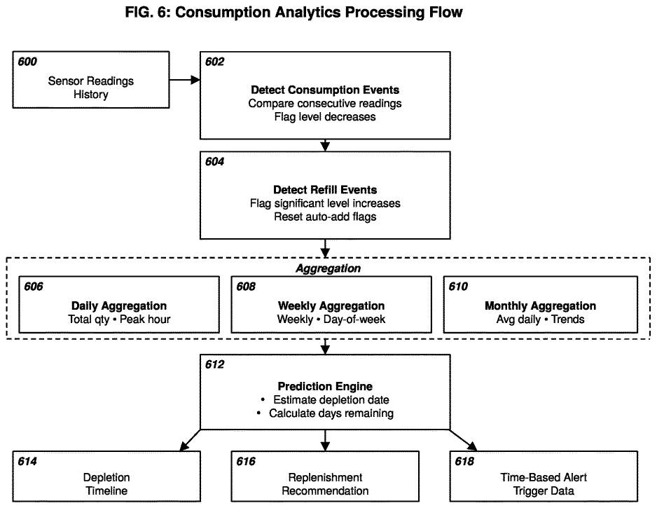

### 5. Consumption Analytics, Event Detection, and Prediction (FIG. 6)

FIG. 6 illustrates consumption analytics processing. Sensor readings history 600 is processed to detect consumption events 602 by comparing consecutive readings and flagging decreases exceeding a threshold. Refill events 604 can be detected by significant level increases, and auto-add flags can be reset after items are removed from a shopping list. The system can compute daily aggregation 606, weekly aggregation 608, and monthly aggregation 610. A prediction engine 612 can estimate depletion dates, calculate days remaining, generate replenishment recommendations 616, and produce time-based alert trigger data 618.

The prediction engine can use statistical models, machine learning models, or hybrid approaches. Models can be trained per container, per product type, or across users. The system can include adaptive thresholds, personalized usage models, model updates and retraining, and optionally federated or distributed learning. Anomaly detection can identify unusual usage, sensor drift, or other abnormal conditions based on stored inventory levels or sensor data.

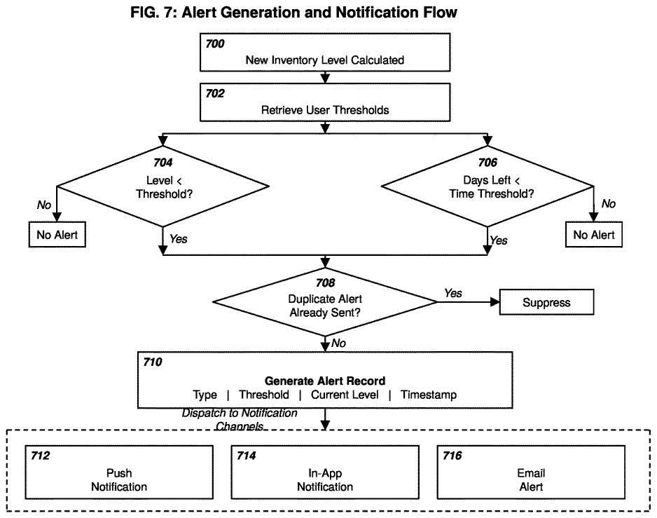

### 6. Alert Generation and Notification (FIG. 7)

FIG. 7 depicts alert generation. After a new inventory level is calculated (step 700), user thresholds are retrieved (step 702). The system evaluates whether a level threshold is breached (step 704) and whether a time-to-depletion threshold is breached (step 706). If an alert condition exists, duplicate suppression can be applied (step 708), and an alert record can be generated including type, threshold, current level, and timestamp (step 710). Notifications can be dispatched via push 712, in-app 714, email 716, SMS, webhook, or other channels.

Alert policies can include escalation, quiet hours, bundling, rate limiting, and re-notification rules. Thresholds can be absolute (for example volume remaining) or relative (for example percentage remaining). Time-based thresholds can consider predicted delivery time, reorder lead times, or subscription schedules.

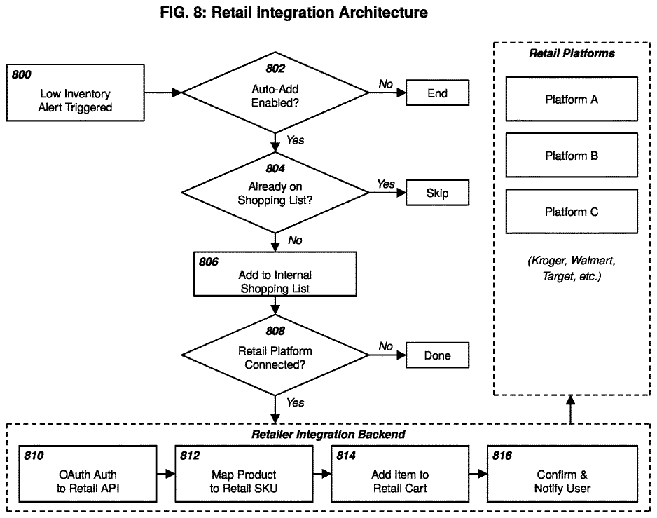

### 7. Shopping List and Retail Integration (FIG. 8)

FIG. 8 illustrates an exemplary retail integration architecture. When a low inventory alert is triggered (step 800), the system can check whether auto-add is enabled (step 802) and whether the item is already on a shopping list (step 804). If not, the item is added to an internal shopping list (step 806). If a retail platform is connected (step 808), the system can authenticate to a retail API (step 810), map the product to a retailer SKU (step 812), add the item to a retailer cart (step 814), and confirm and notify the user (step 816).

Retail integration can support multiple retailers, subscriptions, enterprise procurement workflows, and API-only deployments. Authentication can be OAuth-based, token-based, or delegated through an enterprise identity provider. The system can maintain mappings between internal product records and retailer identifiers, including pack size, substitution preferences, and allowed brands.

Constrained Auto-Reorder (Optional, Off by Default). In certain embodiments, the system supports a constrained auto-reorder mode that is off by default and requires explicit user opt-in to enable. When enabled, the system may place orders automatically subject to user-defined constraints such as maximum spend, maximum frequency, approved retailers or aggregators, preferred brands or substitutions, delivery timing constraints, and approval workflows. In some embodiments, the system requires user approval for each cart-add action by default, and constrained auto-reorder is provided as a distinct optional feature path layered on top of the default shopping list and user-approved cart workflow.

Duplicate Suppression and Refill Coupling. In some embodiments, the system prevents duplicate list entries or cart additions by coupling duplicate suppression to refill detection. For example, after an item is added to a list or cart due to a low level condition, the system may inhibit adding the same item again until a refill event is detected for that container or until a reset condition is satisfied.

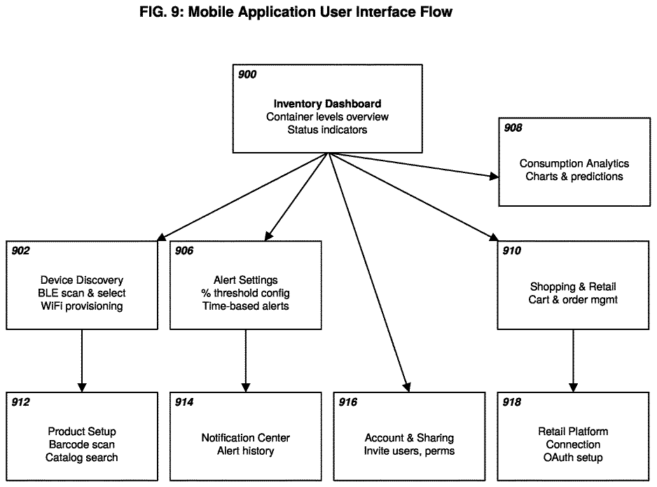

### 8. User Interface and Sharing (FIG. 9)

FIG. 9 illustrates a mobile application flow including an inventory dashboard 900, device discovery 902, product setup 912, alert settings 906, notification center 914, consumption analytics 908, account and sharing 916, shopping and retail integration 910, and retailer platform connection 918. The system can support role-based permissions, household sharing, enterprise dashboards, and audit logs.

In some embodiments, the application supports barcode scanning, catalog search, and custom product creation. A container may be associated with one or more products, and a product may be associated with one or more containers. The system may support location tagging (for example pantry, garage, clinic room) and multi-location monitoring.

### 9. Retrofit Embodiments and Alternative Sensor Placement

In addition to container systems with integrated sensor devices, the disclosed technology includes retrofit and add-on embodiments to prevent design-around. Non-limiting examples include: (i) a retrofit lid compatible with third-party containers and (ii) an electronics module attachable to a container, lid, or enclosure. These configurations may be used individually or in combination.

### 10. Security, Updates, and Data Management

Security can include device identity verification, encrypted transport (for example TLS), signed firmware, and secure boot. Over-the-air (OTA) updates can be supported to add features, adjust sensing algorithms, and patch vulnerabilities. The system can support local buffering and delayed upload when connectivity is intermittent, and can support message acknowledgements and retries via the message broker.

Data retention policies can be configurable. The system can store raw sensor readings, derived levels, and aggregations. Users may export data and may manage privacy settings for shared access.

### 11. Expiry Management

Expiry management may be implemented for monitored products having an expiration attribute or shelf-life, and is an optional enhancement that complements level-based replenishment. As used herein, an “expiration attribute” includes, by way of non-limiting example, an expiry date, use-by date, best-by date, open date, discard date computed based on open date, and optionally a batch or lot identifier for enterprise use.

In some embodiments, the expiration attribute is captured during setup or refill. For example, a mobile application may present a refill workflow that prompts a user to confirm the product identity and to enter or scan an expiry date. In some embodiments, the expiration attribute is captured by scanning a barcode or QR code, reading an NFC tag, recognizing printed text using optical character recognition (OCR), parsing a receipt, importing data from a retailer order confirmation, or receiving a value from an enterprise inventory system.

In some embodiments, expiry-based alerts are generated independently of low-inventory alerts. Non-limiting examples include an expiring-soon alert when an expiration attribute is within a configurable time window and an expired alert when the expiration attribute is past.

In some embodiments, an expiration attribute may be updated. For example, upon detection of a refill event, the system may reset or prompt for a new expiration attribute. In some embodiments, the system supports an “open date” workflow for products whose shelf-life changes after opening and may compute a discard date as open date plus a stability duration.

In some embodiments, an expiration attribute may be inferred. For example, if the product type is known and a refill event is detected, the system may assign a default shelf-life value or prompt the user to confirm an inferred expiry. In some embodiments, the system maintains a confidence metric for an expiration attribute and may request user confirmation when confidence is below a threshold.

Expiry embodiments may be applied to household items, pet food and medication, and enterprise supplies such as medical consumables. In enterprise embodiments, expiration attributes may be tracked per lot number and may support recalls, compliance reports, and audit logs.

### 11a. Expiry Management (Optional Enhancement)

Expiry management may be implemented for monitored products having an expiration attribute or shelf-life, and is an optional enhancement that complements level-based replenishment. As used herein, an “expiration attribute” includes, by way of non-limiting example, an expiry date, use-by date, best-by date, open date, discard date computed based on open date, and optionally a batch or lot identifier for enterprise use. In certain embodiments, expiry management is enabled selectively on a per-container or per-product basis and is disabled by default for products that do not have an expiration attribute or for which a user does not wish to track expiration. In such embodiments, the system continues to perform level-based monitoring and replenishment without requiring expiration attributes.

In some embodiments, the expiration attribute is captured during setup or refill. For example, a client application may present a refill workflow that prompts a user to confirm product identity and to enter or scan an expiry date. In some embodiments, the expiration attribute is captured by scanning a barcode or QR code, reading an NFC tag, recognizing printed text using optical character recognition (OCR), parsing a receipt, importing data from a retailer or aggregator order confirmation, or receiving a value from an enterprise inventory system. In some embodiments, the expiration attribute is stored in association with a container record such that expiration tracking is performed at an individual container level.

In some embodiments, expiry-based alerts are generated independently of low-inventory alerts. Non-limiting examples include an expiring-soon alert when an expiration attribute is within a configurable time window and an expired alert when the expiration attribute is past. In some embodiments, the system generates a replacement recommendation when an item is expired or expiring and a predicted depletion metric indicates insufficient quantity before replacement can be obtained.

In some embodiments, an expiration attribute may be inferred. For example, if a product type is known and a refill event is detected, the system may assign a default shelf-life value based on a product profile and may prompt a user to confirm an inferred expiry. In some embodiments, the system maintains a confidence metric for an expiration attribute and may request user confirmation when confidence is below a threshold.

In some embodiments, an expiration attribute may be updated. For example, upon detection of a refill event, the system may reset or prompt for a new expiration attribute. In some embodiments, the system supports an “open date” workflow for products whose shelf-life changes after opening and may compute a discard date as open date plus a category-specific stability duration.

Expiry embodiments may be applied to grocery items, pet food and medication, and enterprise supplies such as medical consumables. In enterprise embodiments, expiration attributes may optionally be tracked per lot number and may support recalls, compliance reports, and audit logs.

### 11.1 Open-Date Discard Rules and Use-Event Triggers (Optional)

Certain products have a shelf-life that changes after opening, activation, or first use. In some embodiments, the system supports an open-date workflow that captures an open date and computes a discard date as open date plus a stability duration. The open date may be captured explicitly (for example user confirmation in a client application) or inferred from a use-event trigger.

Non-limiting use-event triggers include detection of a lid-open event, detection of motion consistent with dispensing, pump actuation counts, a significant level decrease within a short time window, a first consumption event after a refill event, or a user interaction indicating first use. In some embodiments, the stability duration is product-specific and can be retrieved from a product profile, a catalog, a manufacturer record, or a user-entered value. The system may store multiple stability rules, including temperature dependent rules (for example refrigerated versus room temperature) and packaging dependent rules (for example opened pouch versus sealed container).

Notifications may include open-date capture prompts, discard-date reminders, expiring-soon alerts relative to a discard date, and expired alerts. In some embodiments, discard-date alerts are prioritized higher than low-inventory alerts for safety-critical items such as medications or infant products.

### 11.2 Expiry and Depletion Coordination, Waste-Risk, and Pack Size Optimization (Optional)

In some embodiments, the system combines expiration attributes with predicted depletion metrics to determine whether an on-hand quantity in a container is likely to be consumed before expiration. If the system predicts that a product will expire prior to consumption, the system may generate a recommendation to accelerate consumption, adjust a reorder quantity, select a smaller pack size, or delay purchase until a later time window. In some embodiments, this analysis is performed at an individual container level without requiring consolidation across multiple containers of the same product type.

In some embodiments, the system computes a waste-risk metric based on a relationship between (i) a predicted consumption time or predicted depletion metric and (ii) an expiration time (expiry date or discard date). The waste-risk metric may drive user interface indicators, may affect alert priorities, and may influence replenishment actions. For example, when waste-risk is above a threshold, the system may inhibit automatic reordering and may instead prompt for user approval or suggest a smaller pack size.

### 11.3 Auto-Reorder Controls in View of Expiry (Optional, Off by Default)

In some embodiments, constrained auto-reorder is off by default and requires affirmative user opt-in. When enabled, automatic reordering may be subject to user-defined constraints such as maximum spend, maximum frequency, approved retailers or aggregators, delivery timing constraints, and approval workflows. In some embodiments, the system requires user approval for cart-add actions by default, and auto-reorder is provided as a distinct optional feature path layered on top of the default shopping list and user-approved cart workflow.

In some embodiments, the system inhibits an automatic reorder action when (i) an expiration attribute indicates an on-hand quantity is predicted to expire prior to consumption, (ii) a waste-risk metric exceeds a threshold, or (iii) an expiration attribute has low confidence and requires user confirmation.

### 11.4 Expiration Attribute Sources, Confidence Scoring, and Audit (Optional)

The expiration attribute may be captured or refreshed in multiple ways. Non-limiting examples include manual entry, barcode scan, QR scan, NFC tap, OCR capture of printed expiry information from a label, receipt parsing, retailer or aggregator order confirmation import, integration with a pharmacy system, or integration with an enterprise resource planning (ERP) or inventory system.

In some embodiments, the system assigns a confidence score to an expiration attribute based on the source. For example, an expiration attribute obtained from OCR may receive a lower confidence score than an expiration attribute imported from an order record, and a user-confirmed value may receive the highest confidence score. When confidence is below a threshold, the system may prompt a user to confirm or correct the expiration attribute. In some embodiments, the system stores a prior value, an updated value, and an audit record including source and timestamp.

Although specific embodiments have been described, numerous modifications and variations will be apparent to those of ordinary skill in the art in view of this disclosure. The embodiments were chosen and described to explain principles of the invention and practical applications, and to enable others skilled in the art to understand the disclosure for various embodiments and with various modifications suited to a particular use. Accordingly, the scope of the invention is defined by the claims and their equivalents, and not by the foregoing description.

No feature is intended to be essential unless expressly stated as such. Headings are provided for convenience only and shall not be interpreted to limit the disclosure. The present disclosure expressly contemplates claiming any described feature, function, step, or combination thereof, and expressly supports amendments that add, delete, or rearrange claim elements consistent with this disclosure.

1. An automated inventory monitoring system comprising:
one or more sensor devices each associated with a respective container, each sensor device including a processor, a power system, at least one sensor configured to generate a fill-state signal indicative of an amount of product remaining, and at least one wireless communication interface;
a data processing subsystem configured to receive telemetry from the one or more sensor devices over a network, validate the telemetry, compute an inventory level for each respective container based at least in part on the fill-state signal and container configuration data, and store computed inventory levels in persistent storage; and
an alerting subsystem configured to compare the computed inventory level to one or more user-configurable thresholds and generate a notification when a threshold condition is satisfied;
wherein the system optionally includes an analytics subsystem configured to analyze stored inventory levels over time to detect consumption events, detect refill events, estimate a consumption rate, and generate a predicted depletion metric, and
wherein the alerting subsystem is optionally configured to compare the predicted depletion metric to one or more user-configurable thresholds.

2. The system of claim 1, wherein the at least one sensor comprises a non-contact distance ranging sensor oriented to measure a distance from the sensor device to a product surface within the respective container.

3. The system of claim 2, wherein the non-contact distance ranging sensor comprises a time-of-flight sensor.

4. The system of claim 1, wherein the one or more sensor devices are provisioned using Bluetooth Low Energy and transmit telemetry using Wi-Fi.

5. The system of claim 1, wherein the one or more sensor devices comprise at least one of: a lid-integrated sensor device, a retrofit lid, or an attachable module configured for attachment to a third-party container.

6. The system of claim 1, further comprising a shopping workflow subsystem configured, responsive to the threshold condition, to add an item corresponding to a monitored product to an internal shopping list.

7. The system of claim 6, wherein the shopping workflow subsystem is configured to connect a user account to at least one retailer platform or aggregator platform using OAuth-based authentication.

8. The system of claim 7, wherein the shopping workflow subsystem is configured to maintain a product mapping record that maps a monitored product to a retailer or aggregator stock keeping unit (SKU) and to use the product mapping record to prepare a cart-add request.

9. The system of claim 6, wherein the shopping workflow subsystem is configured to add an item to a retailer or aggregator cart only after receiving user approval via a client application.

10. The system of claim 6, wherein the shopping workflow subsystem is configured to apply duplicate suppression such that an item is not re-added to the internal shopping list or a cart until a refill event is detected or a reset condition is satisfied.

11. The system of claim 1, further comprising an optional expiry management subsystem configured to store, infer, or receive an expiration attribute for a monitored product associated with the respective container, compute an expiry metric based on the expiration attribute, and generate an expiry-based notification when the expiry metric satisfies an expiring-soon threshold or an expired threshold.

12. A method of automated inventory monitoring, the method comprising:
configuring operational network connectivity for a sensor device using a first communication mechanism;
periodically generating, by a sensor of the sensor device, a fill-state signal indicative of an amount of product remaining in a container;
transmitting telemetry including the fill-state signal to a network-accessible data processing service;
computing an inventory level based at least in part on the fill-state signal and container configuration data;
storing the inventory level with a timestamp;
generating a notification when the inventory level satisfies a user-configurable threshold; and
optionally associating the sensor device with a user account using a secure adoption token.

13. The method of claim 12, wherein configuring operational network connectivity comprises establishing an encrypted Bluetooth Low Energy connection between a client application and the sensor device and securely transferring Wi-Fi credentials to the sensor device.

14. The method of claim 12, wherein optionally associating the sensor device with the user account comprises generating the secure adoption token at a server, storing the secure adoption token with an expiration time, receiving the secure adoption token from the client application, and validating the secure adoption token prior to associating the sensor device with the user account.

15. The method of claim 12, wherein computing the inventory level comprises converting a measured distance to a level percentage using a stored container height parameter and a sensor offset parameter.

16. The method of claim 12, further comprising, responsive to the threshold condition, adding an item corresponding to a monitored product to an internal shopping list.

17. The method of claim 16, further comprising connecting a user account to a retailer platform or aggregator platform using OAuth-based authentication.

18. The method of claim 17, further comprising mapping the monitored product to a retailer or aggregator SKU using a product mapping record stored in persistent storage.

19. The method of claim 16, further comprising transmitting a cart-add request to a retailer platform or aggregator platform only after receiving user approval.

20. The method of claim 16, further comprising applying duplicate suppression such that an item is not re-added to the internal shopping list or a cart until a refill event is detected or a reset condition is satisfied.

21. The method of claim 12, further comprising optionally storing, inferring, or receiving an expiration attribute for the monitored product and computing an expiry metric based on the expiration attribute.

22. The method of claim 21, wherein the expiration attribute includes an open date and a discard date computed as the open date plus a category-specific stability duration.

23. A sensor device for automated inventory monitoring, the sensor device comprising:
a housing configured for integration with a container lid or for retrofit attachment to a third-party container;
a processor;
a power system;
at least one non-contact distance ranging sensor configured to generate a fill-state signal indicative of an amount of product remaining;
a short-range wireless interface configured for provisioning; and
an operational wireless interface configured to transmit telemetry including the fill-state signal to a remote service;
wherein the processor is configured to manage power states including a low-power sleep state and to transmit telemetry according to a scheduled interval or an event-triggered interval.

24. The sensor device of claim 23, wherein the non-contact distance ranging sensor comprises a time-of-flight sensor.

25. The sensor device of claim 23, wherein the short-range wireless interface comprises Bluetooth Low Energy and the operational wireless interface comprises Wi-Fi.

26. The sensor device of claim 23, wherein the housing comprises a retrofit lid configured to couple to a third-party container.

27. The sensor device of claim 23, wherein the housing comprises an attachable module configured to attach to a container body, lid, or enclosure.

28. The sensor device of claim 23, wherein the processor is configured to buffer telemetry locally when network connectivity is unavailable and transmit buffered telemetry after connectivity is restored.

29. The sensor device of claim 23, wherein the processor is configured to support cryptographically verified over-the-air firmware updates.

30. The sensor device of claim 23, further comprising an optional camera, and wherein the processor is configured to capture image data to validate fill-level estimation or to perform optical character recognition for expiration attribute capture.

31. The sensor device of claim 23, further comprising at least one use-event trigger sensor comprising a lid-open sensor, motion sensor, or actuation sensor used to infer an open date for discard-date computation.

32. The system of claim 1, wherein the system is configured to monitor each container independently such that a consolidated inventory view across multiple containers of a same product type and first-expire-first-out (FEFO) prioritization across the multiple containers are not required.
